(19) United States
(12) Patent Application Publication
(10) Pub. No.: US 2009/0310237 A1
(43) Pub. Date: Dec. 17, 2009

(54) LANE CHANGE AID SIDE-MIRROR SYSTEM

(75) Inventors: Kwang-Keun Shin, Rochester Hills, MI (US); Jihan Ryu, Rochester Hills, MI (US); Jin-Woo Lee, Rochester Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/140,067

(22) Filed: Jun. 16, 2008

(51) Int. Cl. B60R 1/07

(52) U.S. Cl. 359/843

(57) ABSTRACT

A vehicle-mounted system for automatically adjusting a viewing angle of at least one rear-view mirror of a vehicle. The system includes a sensing unit for detecting and obtaining the positional parameters of an object in a side blind zone of the vehicle. The system also includes a control unit that is capable of adjusting the rear-view mirror based on the positional parameters received from the sensing unit, to facilitate viewing of the object by a driver of the vehicle.

### BACKGROUND OF THE INVENTION

1. Field of the Invention

This invention relates generally to a system and method for adjusting the viewing angle of a rear-view vehicle mirror and, more particularly, to a system and method for detecting objects proximal to the rear end of a vehicle, for example, in a side blind zone of the vehicle, and automatically adjusting the viewing angle of the rear-view mirrors of the vehicle to facilitate viewing of the objects.

2. Discussion of the Related Art

There is a constant effort in the automotive industry to enhance the safety of vehicles and their occupants. An area of concern is the limited view provided by the rear-view mirrors of a vehicle, which could result in problems while changing lanes when a vehicle coming from behind and proximal to the rear end of the vehicle in the side blind zone (SBZ) cannot be seen.

One known system addresses this problem by using a vehicle-mounted radar system to detect an object in the SBZ of the vehicle and sound a warning beep or display a warning sign if the object is detected. Although such systems warn the driver of a vehicle about the approach of an object in the SBZ, they do not provide any information about the position and distance of the objects. Further, in such systems, the warning beep or sign is generated even when the object in the SBZ of the vehicle is not another vehicle, but a potentially unthreatening object such as a railing, a tree or a pedestrian pathway.

A need, therefore, exists for systems that will help to provide positional information about objects in the SBZ of a vehicle to minimize the risk of collisions.

### SUMMARY OF THE INVENTION

In accordance with the teachings of the present invention, a system and method for adjusting the viewing angle of at least one rear-view mirror of a vehicle are disclosed to reduce the risk of a collision when changing lanes or reversing a vehicle The system includes at least one sensing unit that is configured to obtain one or more positional parameters corresponding to at least one object proximal to the rear end of a vehicle, especially in its side blind zone (SBZ). The system also includes at least one control unit that automatically adjusts the at least one rear-view mirror based on the one or more positional parameters.

Additional features of the present invention will become apparent from the following description and appended claims, taken in conjunction with the accompanying drawings.

### BRIEF DESCRIPTION OF THE DRAWINGS

FIG. 1 is a plan view, of a vehicle traveling on a road with an object proximal to the rear end of the vehicle;

FIG. 2 is a block diagram of a system for adjusting the viewing angle of a rear-view mirror of a vehicle, according to an embodiment of the present invention;

FIG. 3 is an illustration of a vehicle with at least one rear-view mirror that can be adjusted to view an object proximal to the rear end of the vehicle, especially in its side blind zone (SBZ), according to an embodiment of the present invention;

FIG. 4 is a flow diagram showing a method for a rear-view mirror of a vehicle to view an object proximal to the rear end of the vehicle, according to an embodiment of the present invention;

FIG. 5 is a plan view of a vehicle with another vehicle approaching from behind;

FIG. 6 illustrates a comparison between a vehicle that does not use a system for automatic rear-view mirror adjustment and a vehicle that does use a system for automatic rear-view mirror adjustment, in accordance with an embodiment of the present invention;

FIG. 7 and FIG. 8 illustrate two exemplary situations in which the present invention can be activated; and

FIG. 9 is a flow chart illustrating an exemplary application of the method disclosed in the present invention.

### DETAILED DESCRIPTION OF THE EMBODIMENTS

The following discussion of the embodiments of the invention directed to a system and method for detecting an object in a blind zone of a vehicle and automatically adjusting the viewing angle of a rear-view mirror on the vehicle so that the object is visible to the vehicle driver is merely exemplary in nature, and is in no way intended to limit the invention or its applications or uses.

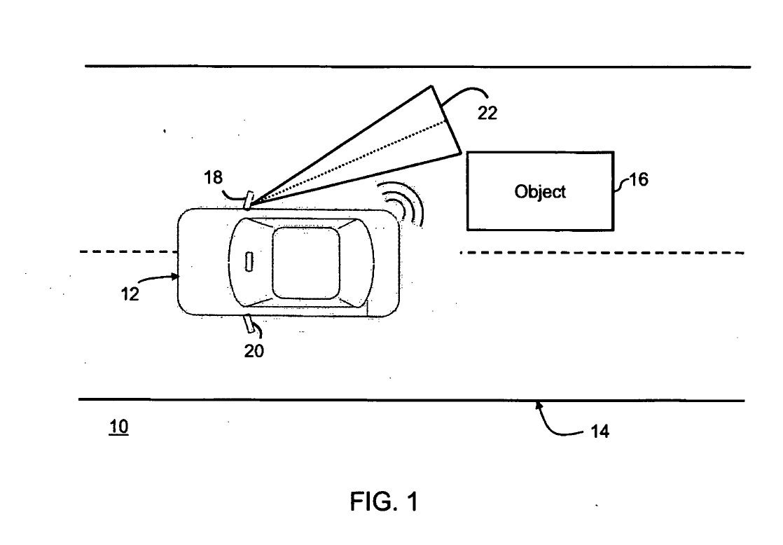

FIG. 1 illustrates a vehicle 12 traveling on a road 14 with an object 16, such as another vehicle, proximal to the rear end of the vehicle 12. The vehicle 12 includes a passenger side rear-view mirror 18 and a driver side rear-view mirror 20. The passenger side rear-view mirror 18 has a rear viewing zone 22. The rear viewing zone of a mirror is the entire area visible to a viewer of the mirror. For example, the rear viewing zone 22 is the entire area visible to the driver of the vehicle 12 in the passenger side rear-view mirror 18. The rear viewing zone 22 provides the driver of the vehicle 12 with an estimate of the distance and approach of the object 16 on the road 14. However, when a rearview mirror of a vehicle is fixed, the rear viewing zone is limited. Consequently, it is possible that the object 16 proximal to the rear end of the vehicle 12 falls outside of the rear viewing zone 22 of the rear-view mirror 18. In such a condition, the object 16 is said to fall in the side blind zone (SBZ) of the vehicle 12. Such positions of the object 16 may pose a threat to the safety of the occupants of the vehicle 12, for example, in situations when the vehicle 12 has to change lanes or reverse its direction.

The illustrations in FIG. 1 form the environment in which the various embodiments of the present invention can be practiced. The present invention eliminates the potential SBZ formation to enhance the safety of the occupants of the vehicle 12.

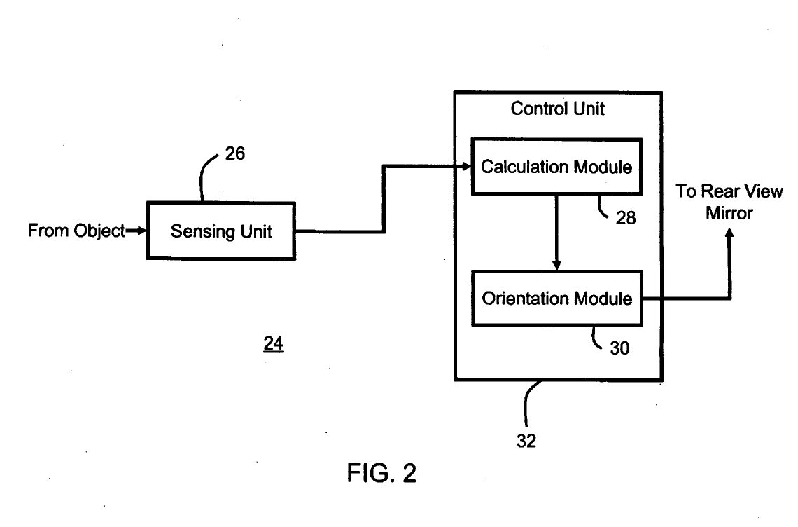

FIG. 2 is a block diagram of a system 24 for adjusting the viewing angle of a rear-view mirror of a vehicle, according to an embodiment of the present invention. The system 24 includes a sensing unit 26 that is configured to obtain information pertaining to the positional parameters of an object proximal to the rear end of the vehicle. Examples of the sensing unit 26 include, but are not limited to, radar devices, video cameras, etc. In one exemplary embodiment, if a radar device is used as the sensing unit 26, it can include a transmitter module to emit radio waves and a collector module to collect reflected waves from the object. The time lag between the emitted and collected waves is used to estimate the position and distance of the object.

The system 24 also includes a control unit 32 that receives information from the sensing unit 26 and processes the information to effect the adjustment of the rear-view mirror of the vehicle. The control unit 32 includes a calculation module 28 and an orientation module 30 that are coupled to each other. The calculation module 28 calculates a mirror-adjustment angle based on the positional parameters of the object proximal to the rear end of the vehicle. Thereafter, the orientation module 30 adjusts the rear-view mirror of the vehicle based on the mirror-adjustment angle. In one embodiment, a motor (not shown) is coupled to the orientation module 30. The orientation module 30 signals the motor which in turn rotates the rear-view mirror based on the mirror-adjustment angle. In another exemplary embodiment, the orientation module 30 is coupled to a power-adjustable rear-view mirror. The orientation module 30 signals an actuating system of the power-adjustable rear-view mirror, which in turn rotates the mirror, based on the mirror-adjustment angle. However, it will be readily apparent to any person with ordinary skill in the art that the mirror adjustment can be effected by methods other than those discussed in the exemplary embodiments given above. The rear-view mirror is adjusted such that in its final adjusted position, an object located in the SBZ of the vehicle is visible to the driver of the vehicle.

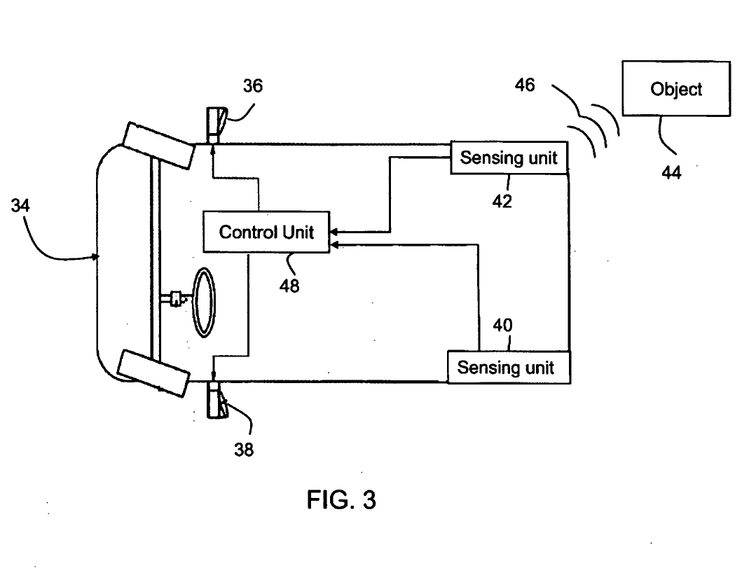

FIG. 3 is a plan view of a vehicle 34 having a driver side rear-view mirror 38 and a passenger side rear-view mirror 36 that can be automatically adjusted to view an object 44 in the SBZ of the vehicle 34. The vehicle 34 includes at least one sensing unit to obtain information relating to the positional parameters of an object proximal to the rear end of the vehicle 34. For the purpose of this description, the vehicle 34 is shown to include two sensing units 42 and 40. In one embodiment, the sensing units 42 and 40 can be radar devices. However, it will be readily apparent to any person with ordinary skill in the art that the sensing units 40 and 42 can be other than those discussed in the exemplary embodiment above. The radar device 42 emits and collects radio waves 46 to obtain the positional parameters of the object 44 proximal to the rear end of the vehicle 34. The vehicle 34 also includes a control unit 48 that receives information pertaining to the positional parameters of the object 44. A mirror-adjustment angle is calculated and the mirror 36 is adjusted by an angle that corresponds to the mirror-adjustment angle based on the information received. The adjustment of the mirror 36 by the control unit 48 is similar to that described for the control unit 32. The passenger side rear-view mirror 36 is adjusted such that in its final adjusted position, the object 44 proximal to the rear end of the vehicle 34 is visible to the driver of the vehicle 34.

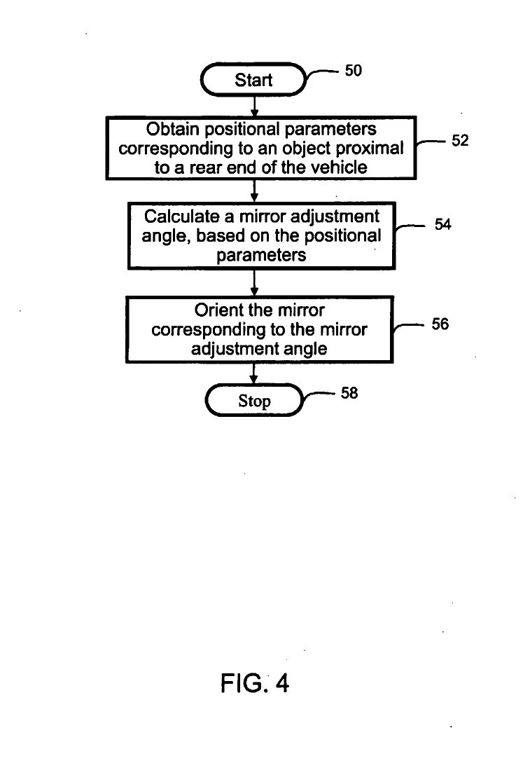

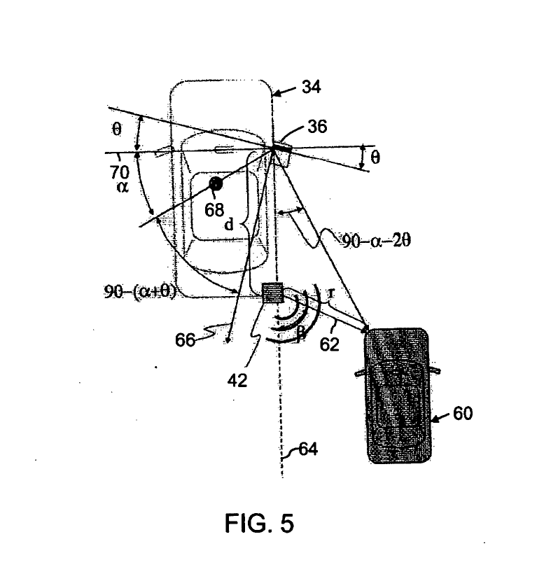

FIG. 4 is a flow chart diagram illustrating a method for adjusting a rear-view mirror of a vehicle to view an object proximal to the rear end of the vehicle. The method for adjusting the rear-view mirror is initiated at step 50. At step 52, the positional parameters of the object are obtained. The positional parameters are obtained by a sensing unit that is included in the vehicle. For example, on the vehicle 34, the sensing unit 42 obtains the positional parameters of the object 44. At step 54, a mirror-adjustment angle is calculated based on the positional parameters from a calculation module. The calculation of the mirror-adjustment angle is described in detail in conjunction with FIG. 5 below. At step 56, the rear-view mirror is adjusted by an angle that corresponds to the mirror-adjustment angle by an orientation module. The adjustment of the rear-view mirror by the orientation module is similar to that described for the orientation module 30. The rear-view mirror is adjusted such that in its final adjusted position, an object proximal to the rear end of the vehicle is visible to the driver of the vehicle. Finally, the method is terminated at step 58.

FIG. 5 is a plan view of the vehicle 34 with another vehicle 60 approaching from behind, and shows the positional and geometrical parameters associated with the calculation of a mirror-adjustment angle θ. The positional parameters may include the cartesian or polar coordinates of the vehicle 60. However, it will be readily apparent to any person with ordinary skill in the art that the positional parameters can be other than the cartesian and polar coordinates. For the purpose of this description, the positional parameters of the vehicle 60 are taken to be the polar coordinates. The positional parameters include a radial co-ordinate r, which is the radial distance of a point on the vehicle 60 from an origin point on the sensing unit 42. For the purpose of this description, the origin point is considered to be at the same vertical height as the point on the vehicle 60. Furthermore, the origin point is at the same vertical height as a pre-defined point on the passenger side rear-view mirror 36. However, it will be readily apparent to a person with ordinary skill in the art that the invention can also be practiced when the origin point, the point on the vehicle 60 and the pre-defined point on the rear-view mirror 36 are at different vertical heights by accordingly modifying equation (1) below. In one embodiment, the point on the vehicle 60 can be a point nearest to the origin point.

The positional parameters also include an angle β, which is the angle between a radial line 62 joining the origin point and the point on the vehicle 60, and a line 64 joining the origin point and the pre-defined point on the passenger side rear-view mirror 36. The line 64 is substantially a longitudinal axis of the vehicle 34.

Further, FIG. 5 also depicts geometrical parameters of the vehicle. The geometrical parameters include an angle α and a distance d. The angle α is the angle between a line of sight 66 of the driver 68 while viewing the passenger side rear-view mirror 36 and a transverse axis 70 of the vehicle 34. Further, the distance d is a distance between the pre-defined point on the passenger side rear-view mirror 36 and the origin point on the sensing unit 42.

When the sensing unit 42 of the vehicle 34 detects the vehicle 60 proximal to the rear end of the vehicle 34, the control unit 48 adjusts the rear-view mirror 36. The adjustment is such that the passenger side rear-view mirror 36 makes a mirror-adjustment angle θ with the transverse axis 70 of the vehicle 34, and enables the driver 68 to view the vehicle 60 in the passenger side rear-view mirror 36.

The mirror-adjustment angle θ can be calculated as per equation (1), where the terms have the meanings explained in the paragraphs above.

Θ=0.5(90−α−tan⁻¹ [r sin β/(d+r cos β)] (1)

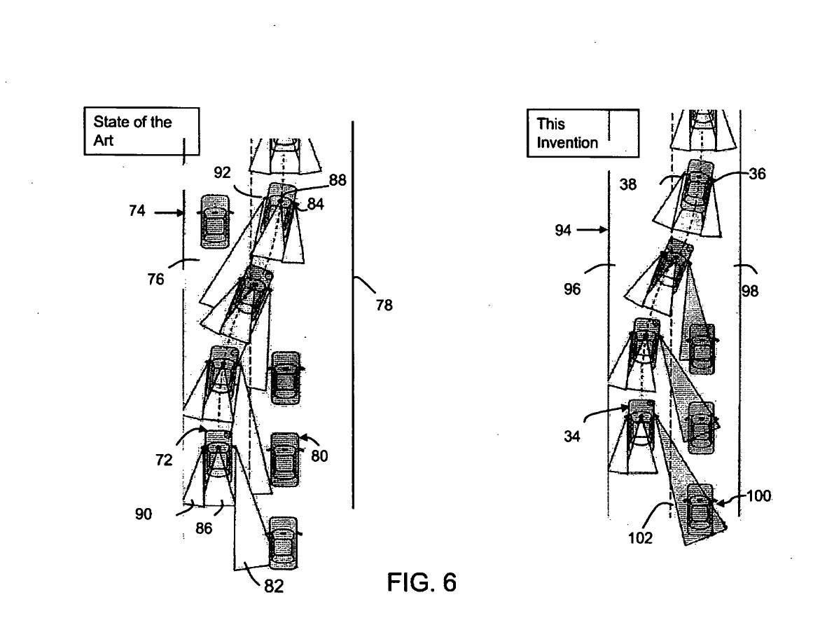

FIG. 6 illustrates the comparison between a vehicle 72, which does not use the system for automatic rear-view mirror adjustment, and the vehicle 34, which does use the system for automatic rear-view mirror adjustment. FIG. 6 shows the vehicle 72 traveling on a two-lane road 74 with a left lane 76 and a right lane 78. The vehicle 72 is shown to be in the process of changing lanes from the left lane 76 to the right lane 78 and another vehicle 80 is approaching from behind the vehicle 72. The vehicle 80 falls outside the rear viewing zone 82 of the passenger side rear-view mirror 84 of the vehicle 72. The vehicle 80 also falls outside the rear viewing zone 86 of an internal rearview mirror 88 and the rear viewing zone 90 of the driver side rear-view mirror 92. Hence, the location and approach of the vehicle 80 cannot be detected by the vehicle 72, since it is located in the SBZ of the vehicle 72. This is a potential threat to the occupants of the vehicle 72 while changing lanes or while reversing direction.

To rectify the limitations in the situation described above, the vehicle 34 is illustrated, which incorporates a system to automatically adjust a rear-view mirror of the vehicle 34, in accordance the present invention. For the purpose of this description, the rear-view mirror is shown to be the passenger side rear-view mirror 36 and the driver side rear-view mirror 38 of the vehicle 34. FIG. 6 shows the vehicle 34 traveling on a two-lane road 94. The vehicle 34 is in the process of changing lanes from a left lane 96 to a right lane 98. A vehicle 100 is approaching the rear end of the vehicle 34. However, in this case the rear viewing zone 102 of the passenger side rear-view mirror 36 of the vehicle 34 is modified such that the vehicle 100 approaching the rear end of the vehicle 34 is visible in the passenger side rear-view mirror 36 of the vehicle 34. The modification of the rear viewing zone 102 takes place, since the rear-view mirror 36 is adjusted by the control unit 48 included in the vehicle 34. The adjustment is by an angle that corresponds to the mirror-adjustment angle Θ calculated on the basis of the positional parameters of the vehicle 100. The adjustment of the passenger side rear-view mirror 36 takes place such that in the final adjusted position, a driver of the vehicle 34 is able to see the vehicle 100 in the SBZ of the vehicle 34 in the passenger side rear-view mirror 36.

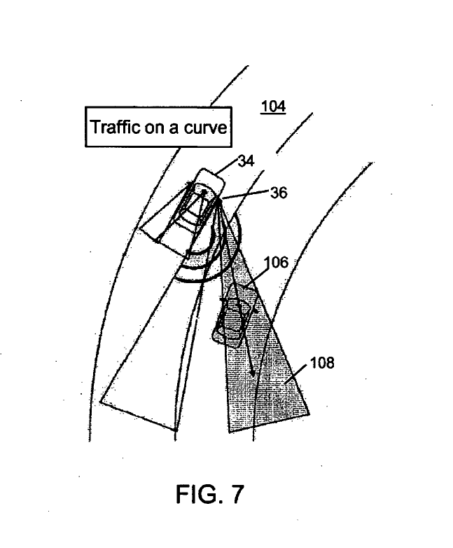

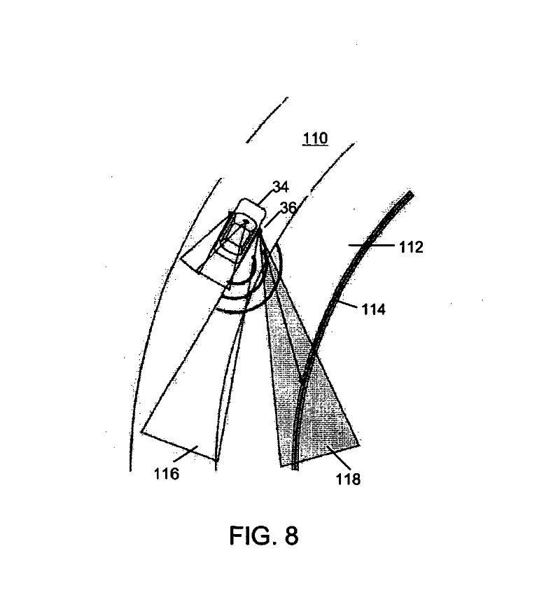

FIG. 7 and FIG. 8 illustrate two exemplary situations in which present invention can be activated. FIG. 7 shows the vehicle 34 taking a turn on a curved road 104. Another vehicle 106 is shown to be proximal to the vehicle 34. However, because of the nature of the bend, the vehicle 106 falls in the SBZ of the passenger side rear-view mirror 36 of the vehicle 34. This creates a potential threat for the occupants of the vehicle 34, since the driver may not be able to view the vehicle 108 in the driver side rear-view mirror. To rectify the limitations described in the aforementioned situation, in accordance with the present invention, the vehicle 34 incorporates a system to automatically adjust the rearview mirrors of the vehicle 34, to enable the driver of the vehicle 34 to view the vehicle 106 in the passenger side rearview mirror. For the purpose of this illustration, the passenger side rearview mirror 36 is shown to be automatically adjustable to modify its rearview zone.

Further, FIG. 8 shows the vehicle 34 moving on a curved road 110. A lane 112 on the curved road 110 is shown to be bordered by a guard rail 114. The guard rail 114 falls in the SBZ of the passenger side rear-view mirror 36 of the vehicle 34. Although the presence of the guard rail 114 does not provide any potential threat to the occupants of the vehicle 34, it is detected by the sensing unit 42. Based on the detection, the passenger side rearview mirror 36 is adjusted. The adjustment is done such that the guard rail 114 can be viewed in the passenger side rear-view mirror 36 of the vehicle 34.

In such an exemplary situation, the existing techniques could have generated warning signals due to detection of the guard rail 114. In the existing techniques, the driver would not be able to distinguish whether the warning signal is due to another vehicle or the guard rail 114, and hence, detection of the guard rail 114 would be a false alarm.

In accordance with the present invention, the driver will be able to view the guard rail 114, and clearly distinguish it from another vehicle.

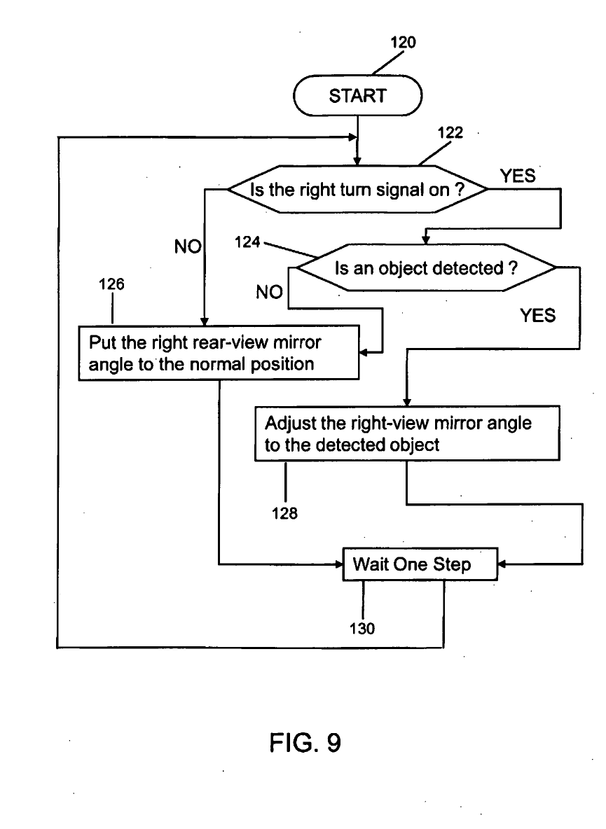

FIG. 9 is a flow chart illustrating an exemplary application of the method disclosed in the present invention. The process is initiated at step 120. At step 122, the process determines whether the right side turn signal has been activated. If the right side turn signal has been activated at step 122, the process determines whether there is a vehicle or object present proximal to the right side rear of the vehicle 34 at step 124. If a vehicle or object is found to be present proximal to the right side rear of the vehicle 34 at the step 124, the right side rear-view mirror 36 is adjusted at step 128 so that the driver of the vehicle 34 is able to view the vehicle or object in the rear-view mirror 36. If the right turn signal has not been activated at the step 122 or no vehicle or objected is detected at the step 124, the rear-view mirror 36 is put into its normal position at step 126. The normal position can be a predefined position of rear-view mirror of the vehicle, as set by the driver of the vehicle, or it can be a predefined position as per the configuration of the vehicle. After the steps 126 and 128, the process is taken to step 130. As the process is a cyclic process, it can be halted for a pre-determined duration of time in accordance with step 130 before it starts over again at step 122.

Various embodiments of the present invention offer one or more advantages. The present invention provides a vehicle system and method for adjusting at least one rear-view mirror of the vehicle. The invention eliminates a potential threat that object approaching a side blind zone of a vehicle poses to a driver or occupants of the vehicle in situations such as changing lanes or reversing direction. This is achieved by automatically adjusting the at least one rear-view mirror, such that the object can be viewed in the at least one rear-view mirror. Furthermore, the invention also solves the problem of false warning signals being activated in earlier vehicle safety systems, which were activated even when there was no potentially threatening object in the vicinity of the rear end of the vehicle.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for adjusting at least one rear-view mirror of a vehicle, said method comprising:
obtaining one or more positional parameters corresponding to the position of at least one object proximal to a rear end of the vehicle; and
adjusting a viewing angle of the at least one rear-view mirror based on the one or more positional parameters so that the object is visible to a driver of the vehicle in the mirror.

2. The method according to claim 1 wherein the at least one object is located in a side blind zone of the vehicle.

3. The method according to claim 1 wherein adjusting the at least one rear-view mirror includes:
calculating a mirror-adjustment angle based on the one or more positional parameters; and
orienting the at least one rear-view mirror based on the mirror-adjustment angle.

4. The method according to claim 1 wherein the one or more positional parameters are obtained from a sensing unit.

5. The method according to claim 4 wherein the sensing unit is selected from the group comprising a radar device and a video camera.

6. The method according to claim 1 wherein the one or more positional parameters correspond to one or more polar coordinates of the at least one object.

7. The method according to claim 1 wherein the one or more positional parameters correspond to one or more cartesian coordinates of the at least one object.

8. A system for adjusting at least one rear-view mirror of a vehicle, said system comprising:
at least one sensing unit configured to obtain one or more positional parameters corresponding to at least one object proximal to a rear end of the vehicle; and
at least one control unit capable of adjusting a viewing angle of the at least one rear-view mirror based on the one or more positional parameters, wherein the at least one rear-view mirror is adjusted to facilitate viewing of an image of the at least one object by a driver of the vehicle.

9. The system according to claim 8 wherein the at least one control unit comprises:
a calculation module configured to calculate a mirror-adjustment angle based on the one or more positional parameters; and
an orientation module capable of orienting the at least one rearview mirror based on the mirror-adjustment angle.

10. The system according to claim 8 wherein the one or more positional parameters correspond to one or more polar coordinates of the at least one object.

11. The system according to claim 8 wherein the one or more positional parameters correspond to one or more cartesian coordinates of the at least one object.

12. The system according to claim 8 wherein the sensing unit is selected from the group comprising a radar device and a video camera.

13. The system according to claim 8 wherein the at least one object is located in a side blind zone of the vehicle.

14. A vehicle comprising:
at least one rear-view mirror;
at least one sensing unit configured to obtain one or more positional parameters corresponding to at least one object proximal to a rear end of the vehicle; and
at least one control unit capable of adjusting a viewing angle of the at least one rear-view mirror based on the one or more positional parameters.

15. The vehicle according to claim 14 wherein the at least one rear-view mirror is adjusted to facilitate viewing of an image of the at least one object by a driver of the vehicle.

16. The vehicle according to claim 14 wherein the at least one object is located in a side blind zone of the vehicle.

17. The vehicle according to claim 14 wherein the at least one control unit comprises:
a calculation module configured to calculate a mirror-adjustment angle based on the one or more positional parameters; and
an orientation module capable of orienting the at least one rearview mirror based on the mirror-adjustment angle.

18. The vehicle according to claim 17 wherein the sensing unit is selected from the group comprising a radar device and a video camera.

19. The vehicle according to claim 14 wherein the one or more positional parameters correspond to one or more polar coordinates of the at least one object.

20. The vehicle according to claim 14 wherein the one or more positional parameters correspond to one or more cartesian coordinates of the at least one object.
